(19) United States
(12) Patent Application Publication
(10) Pub. No.: US 2013/0170233 A1
(43) Pub. Date: Jul. 4, 2013

(54) LAMP DEVICE AND LIGHTING APPARATUS

(71) Applicants: Kenji Nezu, Kanagawa-ken (JP); Shigeru Osawa, Kanagawa-ken (JP); Yuichiro Takahara, Kanagawa-ken (JP); Takeshi Osada, Kanagawa-ken (JP); Toshifumi Masuda, Kanagawa-ken (JP); Hiromichi Nakajima, Kanagawa-ken (JP)

(72) Inventors: Kenji Nezu, Kanagawa-ken (JP); Shigeru Osawa, Kanagawa-ken (JP); Yuichiro Takahara, Kanagawa-ken (JP); Takeshi Osada, Kanagawa-ken (JP); Toshifumi Masuda, Kanagawa-ken (JP); Hiromichi Nakajima, Kanagawa-ken (JP)

(73) Assignee: TOSHIBA LIGHTING & TECHNOLOGY CORPORATION, Kanagawa (JP)

(21) Appl. No.: 13/496,869

(22) PCT Filed: Jul. 15, 2011
(86) PCT No.: PCT/JP2011/066266

§ 371 Date: Mar. 18, 2013

(30) Foreign Application Priority Data
Jul. 16, 2010 (JP) 2010-162079
Nov. 18, 2010 (JP) 2010-258055

(51) Int. Cl. F21V 15/01

(52) U.S. Cl. CPC F21V 15/01
USPC 362/368; 362/373; 362/382

(57) ABSTRACT

A lamp device 14 includes a light-emitting portion 34 in which a semiconductor light-emitting element is used. The light-emitting portion 34 is arranged on the side of one of surfaces of the housing 16. Provided on the side of the other surface of the housing 16 is a metallic cap portion 44 and a lamp pin 46 projecting from the other surface side of the housing 16. The lighting circuit 21 is stored in the housing 16. Then, the lamp device 14 includes lamp pin mounting portions 73 where the lamp pins are to be mounted and the insulating member 47 having an insulating portion 75 interposed between the inner surface of the cap portion 44 and the lighting circuit 21.

### TECHNICAL FIELD

An embodiment of the present invention relates to a lamp device in which a semiconductor light-emitting element is used as a light source and a lighting apparatus using this lamp device.

### BACKGROUND ART

In the related art, there is a lamp device using a cap of GX53 type. The lamp device of this type include a metallic base member. The base member includes a light-emitting module having a semiconductor light-emitting element mounted on one of the surfaces thereof, and a transmissive cover mounted so as to cover the light-emitting module. The base member includes a cap of GX53 type having a pair of lamp pins projecting therefrom mounted on the other surface thereof. In addition, a lighting circuit is stored between the base member and the cap.

### CITATION LIST

### Patent Literature

PTL 1: Japanese Laid-Open Patent Publication No. 2010-129488

### SUMMARY OF THE INVENTION

### Technical Problem

The lamp device as described above is required to radiate heat generated by the semiconductor light-emitting element and the lighting circuit efficiently to the outside when being souped-up, and hence the cap or the like are needed to be formed of a metal as well as the metallic base member. However when the cap is formed of a metal, configuration for mounting the lamp pin and the lighting circuit respectively in an insulated condition so as not to come into contact with the cap is required, and hence there arises a problem that the number of components increases and hence the structure becomes complicated.

It is an object of the invention to provide a lamp device which can be reduced in number of components and can be simplified, and a lighting apparatus using this lamp device.

### Solution to Problem

The lamp device of an embodiment includes a light-emitting portion in which a semiconductor light-emitting element is used. The light-emitting portion is arranged on the side of one of the surfaces. Provided on the side of the other surface of the housing is a metallic cap portion and projecting lamp pins on the side of the other surface the housing. A lighting circuit is stored in the housing. The lamp device includes an insulating member having a lamp pin mounting portion where the lamp pins are to be mounted and an insulating portion interposed between the inner surface of the cap portion and the lighting circuit.

### BRIEF DESCRIPTION OF THE DRAWINGS

FIG. 1 is a cross-sectional view of a lamp device according to a first embodiment.

FIG. 2 is a perspective view of an exploded state of a portion of the same lamp device shown in FIG. 1 viewed from inside in a state in which upper and lower surfaces are inverted upside down.

FIG. 3 is a perspective view of an assembled state of a portion viewed from inside in a state in which upper and lower surfaces of the same lamp device shown in FIG. 1 inverted upside down.

FIG. 4 is a perspective view of part of the same lamp device in an assembled state viewed from the outside.

FIG. 5 is a front view of a base member and a light-emitting module of the same lamp device.

FIG. 6 is a perspective view of the lighting apparatus having the same lamp device and the socket device.

FIG. 7 is a cross-sectional view of a lamp device according to a second embodiment.

FIG. 8 is a perspective view showing part of an insulating body of the same lampdevice.

FIG. 9 is a development elevation showing an example of an insulating sheet of the same lamp device.

FIG. 10 is a development elevation showing another example of an insulating sheet of the same lamp device.

FIG. 11 is a perspective view of part of the same lamp device in a state in which an insulating sheet according to another example is assembled.

FIG. 12 is a cross-sectional view of a lamp device according to a third embodiment.

### DESCRIPTION OF EMBODIMENTS

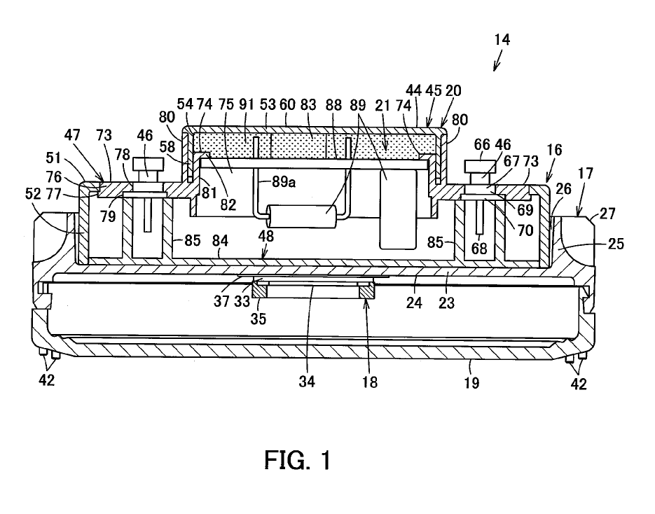

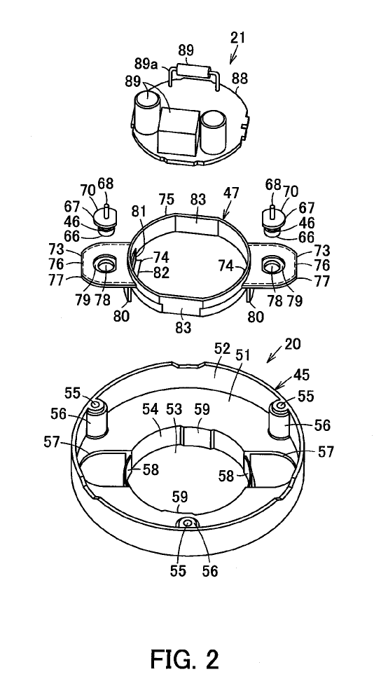

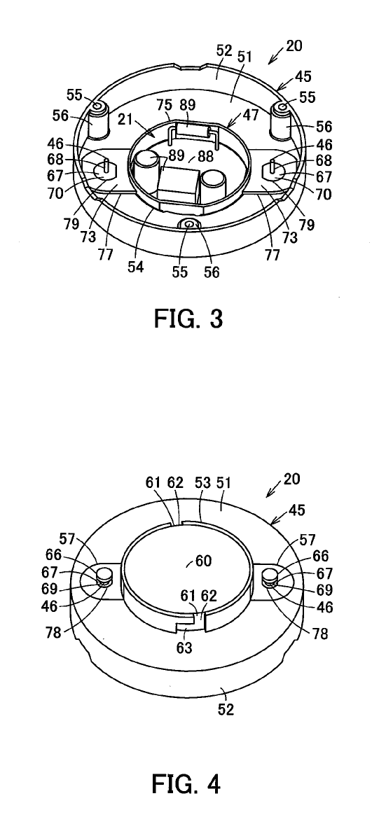

Referring now to FIG. 1 to FIG. 6, a first embodiment will be described.

As shown in FIG. 6, a lighting apparatus 11 is, for example, a down light, and includes a luminaire body 12, a socket device 13 mounted on the luminaire body 12, and a flat-type lamp device 14 demountably mounted on the socket device 13. As regards the directional relationship such as upward and downward directions thereof, description will be given assuming that a light-source side as one of the surfaces of the lamp device 14 is the lower side and the cap side as the other surface is the upper side based on a state in which a flat-type lamp device 14 is attached horizontally.

The luminaire body 12 is, for example, formed of a metal, and is configured to integrally have a reflector function opening on the lower surface thereof.

Subsequently, as shown in FIG. 1 and FIG. 6, the lamp device 14 includes a base member 17, a light-emitting module 18 mounted on a lower surface of the base member 17, a globe mounted on the base member 17 so as to cover the light-emitting module 18, a cap 20 mounted on an upper surface of the base member 17, and a lighting circuit 21 stored in the cap 20. Then, the base member 17 and the cap 20 constitute a housing 16 of the lamp device 14.

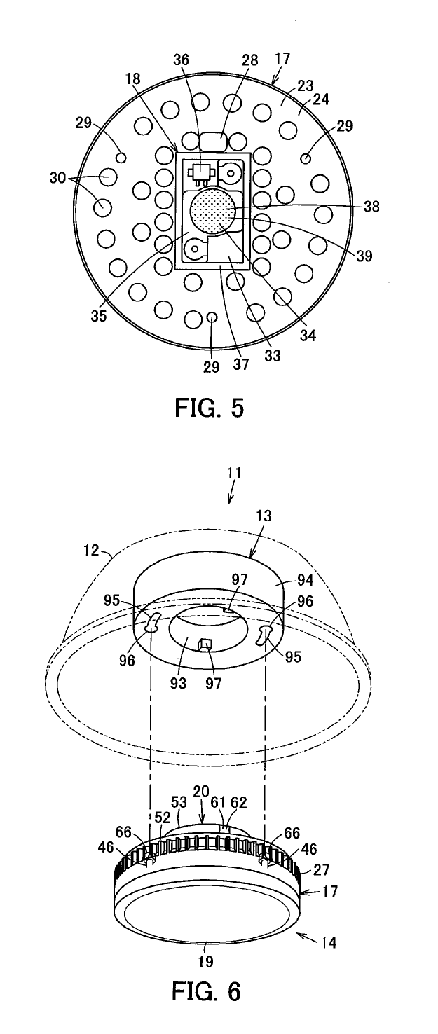

As shown in FIG. 1, FIG. 5, and FIG. 6, the base member 17 is formed integrally with a metal such as aluminum diecast or ceramics superior in heat conductivity and heat radiating properties. The base member 17 includes a substrate mounting portion 23 formed into a flat disk shape. A substrate mounting surface 24 on which the light-emitting module 18 is mounted in tight contact thereto so as to allow heat conduction is formed on a lower surface of the substrate mounting portion 23. A cylindrical substrate-side fitting portion 25 is formed on a peripheral portion of the upper surface of the substrate mounting portion 23. A circular and depressed cap storage portion 26 which allows fitting of the cap 20 is formed on the inner side of the substrate-side fitting portion 25, and a plurality of thermal radiating fins 27 are formed on the outside of the substrate-side fitting portion 25.

The substrate mounting portion 23 is formed with a wiring hole 28 for allowing passage of an electric wire which electrically connects the light-emitting module 18 and the lightening circuit 21, a screw hole, not shown, which allows screwing of a screw for mounting the light-emitting module 18 on the substrate mounting portion 23 in tight contact manner, and a plurality of insertion holes 29 which allow insertion of screws for mounting the cap 20 on the substrate mounting portion 23.

Formed on the substrate mounting surface 24 of the substrate mounting portion 23 is a plurality of depressed portions 30 in a peripheral area except for an area on which the light-emitting module 18 is mounted. Although the depressed portions 30 may be of any shape, when it is a circular shape, a relation d≧φ/4 is preferably satisfied where φ is the diameter of a circle and d is the depth. When it is a rectangular shape, a relation a·b≦2 (a·b) c is preferably satisfied where a is the long side, b is the short side, and c is a depth of the rectangular shape. By the formation of the depressed portions 30, the heat radiation properties may be improved by increasing the surface area of the substrate mounting surface 24 and reduction of the weight of the base member 17 may be achieved. For reference, a hole portion penetrating through the substrate mounting portion 23 may be formed instead of the depressed portions 30, whereby further improvement of the heat radiating properties and weight reduction are achieved.

As shown in FIG. 1 and FIG. 5, the light-emitting module 18 includes a substrate 33, a light-emitting portion 34 formed at the center of the lower surface of the substrate 33, an insulating collar 35 mounted on the lower surface of the substrate 33 so as to cover the periphery of the light-emitting portion 34, and a connector 36 mounted on the lower surface of the substrate 33 and electrically connected to the lightening circuit 21. When the upper surface of the substrate 33 is joined to the substrate mounting surface 24 of the base member 17 via the insulating sheet 37, and a plurality of screws are screwed into the substrate mounting portion 23 of the base member 17 via the insulating collar 35, the substrate 33 comes into tight contact with the base member 17, and hence good heat conductivity from the light-emitting module 18 to the base member 17 is secured.

The base plate 33 is formed into a rectangular shape with a metal such as aluminum diecast or ceramics superior in heat conductivity and heat radiating properties.

In the light-emitting portion 34, semiconductor light-emitting elements 38 such as an LED element or EL elements are used. In this embodiment, LED elements are employed as the semiconductor light-emitting elements 38, and a COB (Chip On Board) system in which a plurality of LED elements are mounted on a substrate 33 is employed. In other words, a plurality of LED elements are mounted on the substrate 33, the plurality of LED elements are electrically connected in series by electric wire bonding, and the plurality of LED elements are integrally covered with a sealing resin 39, which is a transparent resin such as silicone resin mixed with a fluorescent material and sealed thereby. As the LED elements, for example, LED elements emitting blue light are used, and the sealing resin is mixed with a fluorescent material excited by part of the blue light from the LED elements and radiating yellow light. Therefore, the light-emitting portion 34 is formed of the LED elements, which is a semiconductor light-emitting elements 38, the sealing resin 39 and the like, and the surface of the sealing resin 39, which is the surface of the light-emitting portion 34, serves as a light-emitting surface, so that a white illuminating light beam is radiated from the light-emitting surface. As the light emitting portion 34, a system of mounting a plurality of SMD (Surface Mount Device) packages having connection terminals and having the LED elements mounted thereon on the substrate 33 may be employed.

As shown in FIG. 1 and FIG. 6, the globe 19 is formed of a synthetic resin or glass, for example, has translucency and diffusing properties, is fitted to a peripheral edge portion of the base member 17, and is locked by a claw structure so as to cover the light-emitting module 18 mounted on the substrate mounting surface 24 of the base member 17. Provided in the peripheral portion of the surface of the globe 19 is a pair of indicating portions 42 for indicating the positions of the lamp pins.

Also, as shown in FIG. 1 to FIG. 4, the cap 20 is of a GX53 type, and has a cap body 45 which constitutes the cap portion 44. A pair of the lamp pins 46, an insulating body 47, and a cap cover 48 are mounted on the cap body 45, and in addition, a lightening circuit 21 is mounted via the insulating body 47.

The cap body 45 is integrally formed of a metal such as aluminum diecast superior in heat conductivity and heat radiating properties, for example, and includes an annular cap surface portion 51, a cylindrical cap-side fitting portion 52 projecting downward from a peripheral edge portion of the cap surface portion 51, and a cylindrical projecting portion 53 projecting upward from a center area of the cap surface portion 51. Accordingly, the cap body 45 is opened on the lower surface side, and is formed with a lighting circuit storage portion 54 configured to store the lightening circuit 21 in the interior thereof.

Formed on an inner surface of the cap-side fitting portion 52 is a plurality of bosses 56 having mounting holes 55 respectively. The base member 17 and the cap 20 are fixed to each other so as to allow heat conduction by a plurality of screws, not shown, screwed into the mounting holes 55 of the bosses 56 through the insertion holes 29 of the base member 17.

The cap surface portion 51 is formed with a pair of openings 57 at positions symmetry with respect to the center of the cap 20 and corresponding to positions where the pair of lamp pins 46 are arranged. Aside surface of the projecting portion 53, which faces the openings 57, is formed with a holding wall 58 at a position shifted inwardly from the outer peripheral surface of the projecting portion 53. A plurality of flat portions 59 are formed partly on the inner peripheral surface of the projecting portion 53, and a flat-shaped end surface portion 60 is formed on an upper surface of the projecting portion 53.

The projecting portion 53 is formed on the outer peripheral surface thereof with a pair of key grooves 61 at positions symmetry with respect to the center of the cap 20 and shifted from the positions where the pair of lamp pins 46 are arranged. The respective key grooves 61 each formed into an L-shape including a vertical groove 62 formed along the vertical direction so as to communicate with the upper surface of the projecting portion 53, and a lateral groove 63 formed along the circumferential direction of the projecting portion 53 on the lower portion of the projecting portion 53.

The lamp pins 46 is formed of a metal having electric conductivity, is formed with a large-diameter portion 66 at a distal end thereof, and amounting portion 67 to be mounted to the insulating body 47 and a connecting portion 68 to be electrically connected to the lightening circuit 21 at a proximal end thereof. The mounting portion 67 includes a mounting base 69 slightly larger than the large-diameter portion 66, and flange portions 70 still larger in diameter than the mounting base 69. Each of the flange portions 70 is formed with a linear notch partly on its peripheral surface thereof, and is formed into an odd form in the circumferential direction.

The insulating body 47 is integrally formed of a synthetic resin having insulating properties, and includes a pair of lamp pin mounting portions 73 for mounting a pair of the lamp pins 46 respectively, a pair of lighting circuit board holding portions 74 that holds the lighting circuit board of the lightening circuit 21, and an insulating portion 75 interposed between the inner peripheral surface of the cap 20 and the lightening circuit 21 held by the lighting circuit board holding portion 74.

The pair of lamp pin mounting portions 73 is formed at positions symmetry with respect to the center of the insulating body 47, and includes cover portions 76 fitted into the respective openings 57 of the cap body 45 from the lower surfaces thereof and aligned in flush with the upper surface of the cap surface portion 51 of the cap body 45, and abutment portions 77 that come into abutment with the lower surface of the cap surface portion 51 of the cap body 45 in a state in which the cover portions 76 are fitted to the openings 57 of the cap body 45. Formed at the centers of the lamp pin mounting portions 73 are hole portions 78 where the large-diameter portions 66 of the lamp pins 46 can be inserted and mounting bases 69 are fitted, and depressed portions 79 configured to allow the flange portions 70 of the lamp pins 46 to be fitted therein in a state in which the mounting bases 69 of the lamp pins 46 are fitted into the hole portions 78. Each of the depressed portions 79 is formed into an odd form in the circumferential direction so as to match the shape of the flange portion 70 for allowing the flange portion 70 to be fitted without allowing the rotation thereof. Formed from upper surfaces of the lamp pin mounting portions 73 are cover portions 80 which are arranged on the outsides of the holding walls 58 of the projecting portion 53 and aligned in flush with the outer peripheral surface of the projecting portion 53.

The respective lighting circuit board holding portions 74 include holding strips 81 formed so as to project upward from the respective lamp pin mounting portions 73, and arranged inside the holding walls 58 of the projecting portion 53 of the cap body 45. The holding strips 81 are formed at distal ends thereof with claw portions 82 configured to hold the lighting circuit board of the lightening circuit 21. The holding strips 81 have a function as part of the insulating portion 75, and have a function to clamp the holding walls 58 with the cover portions 80 to hold the same.

The insulating portion 75 is formed into a cylindrical shape having an outline which projects both from the lower surfaces and the upper surfaces of the lamp pin mounting portions 73 and is capable of being inserted into the projecting portion 53, and parts of the insulating portion 75 in the circumferential direction are formed with flat portions 83 which are fitted into the flat portions 59 of the projecting portion 53 of the cap 20.

The cap cover 48 is formed of synthetic resin having insulating properties and heat insulating properties, and includes a closing portion 84 configured to close the lower opening of the cap body 45. Formed from the closing portion 84 so as to project therefrom are lamp pin mounting portions 73 of the insulating body 47 and the cylindrical holding portions 85 which come into abutment with the lower surface of the lamp pins 46. The closing portion 84 of the cap cover 48 is formed with a wiring hole, not shown, for allowing passage of an electric wire which electrically connects the light-emitting module 18 and the lightening circuit 21. Then, the cap cover 48 is clamped between the base member 17 and the cap 20 when fixing the base member 17 and the cap 20, and the respective holding portions 85 come into abutment with the lamp pin mounting portions 73 of the insulating body 47 and the lower surfaces of the respective lamp pins 46, and the respective lamp pin mounting portions 73 of the insulating body 47 and the respective lamp pins 46 are held in the cap body 45.

The lighting circuit 21 configures a power circuit that outputs a constant-current DC power, and includes a disk-shaped lighting circuit board 88 and a lighting circuit components 89, which is a plurality of electronic components 89 mounted on the lighting circuit board 88. The lighting circuit board 88 is inserted into the insulating portion 75 of the insulating body 47, comes into abutment with claw portions 82 of a pair of the holding strips 81 of the insulating body 47, and is positioned and held thereby. The lighting circuit board 88 held by the insulating body 47 and mounted on the cap body 45 is arranged in the projecting portion 53 of the cap body 45 and, in this state of arrangement, the space formed between the lower surface of the lighting circuit board 88 and the cap cover 48 becomes larger than the space formed between the upper surface of the lighting circuit board 88 and the end surface portion 60 of the projecting portion 53. Therefore, a large number of lighting circuit components 89 including a large lighting circuit components 89 are mounted mainly on the lower surface of the lighting circuit board 88, and small-sized lighting circuit components 89 such as chip parts or the like having a lead electric wire 89a of the lighting circuit components 89 to be mounted on the lower surface of the lighting circuit board 88 projects therefrom are mounted on an upper surface of the lighting circuit board 88.

An electric wire connected to an input side of an AC power source of the lightening circuit 21 is electrically connected to the connecting portions 68 of the respective lamp pins 46 with an electric wire, and an electric wire connected to an output side of the DC power source of the lightening circuit 21 is electrically connected to the connector 36 of the light-emitting module 18 via the wiring hole of the cap cover 48 and the wiring hole 28 of the base member 17.

A space formed by the inside of the projecting portion 53 of the cap body 45, the insulating body 47 and the lighting circuit board 88 of the lightening circuit 21 is filled with a filling member 91 such as silicone resin, for example, having insulating properties and heat conductive properties, and the insulating body 47 and the lightening circuit 21 are fixed to the cap body 45 by the filling member 91, and efficient conduction of heat generated by the lightening circuit 21 to the cap body 45 is achieved.

In this manner, the lamp device 14 includes a light-emitting portion 34 in which the semiconductor light-emitting elements 38 are used. The light-emitting portion 34 is arranged on the side of one of the surfaces of the housing 16. Provided on the side of the other surface of the housing 16 is a metallic cap portion 44 and the lamp pins 46 projecting from the other surface side of the housing 16. The lighting circuit 21 is stored in the housing 16. Then, the lamp device 14 includes the lamp pin mounting portion 73 where the lamp pins 46 are to be mounted and the insulating member 47 having the insulating portion 75 interposed between the inner surface of the cap portion 44 and the lighting circuit 21.

Subsequently, as shown in FIG. 6, the socket device 13 includes an annular socket body 94 having an opening 93 at the center thereof. Formed on the lower surface of the socket body 94 is a pair of connecting holes 95 which allows insertion and rotation of the respective lamp pins 46 of the lamp device 14 at a position symmetry with respect to the center of the socket device 13. The connecting holes 95 are elongated holes extending along the circumferential direction of the socket body 94 and one end of each of the connecting holes 95 are formed with enlarged-diameter portions 96 which allow insertion of the large-diameter portions 66 of the lamp pins 46. Stored respectively in the respective connecting holes 95 are terminals, not shown, to which the lamp pins 46 inserted into the connecting holes 95 are electrically connected.

Formed on the inner peripheral surface of the socket body 94 is a key 97 configured to fit into a substantially L-shaped key grooves 61 formed on an outer peripheral surface of the projecting portion 53 of the cap 20 in association with the insertion and rotation of the lamp pins 46 of the cap 20 into the connecting holes 95, and support the cap 20 on the socket body 94.

Subsequently, the action of the lighting apparatus 11 of the embodiment will be described.

In order to mount the lamp device 14 on the socket device 13, the projecting portion 53 of the cap 20 of the lamp device 14 is inserted into the opening 93 of the lamp device 14 to adjust the position of the lamp device 14 in the circumferential direction and insert the large-diameter portions 66 of the lamp pins 46 into the enlarged-diameter portions 96 of the connecting holes 95 of the socket device 13. Accordingly, the vertical groove portion 62 of the respective key grooves 61 of the cap 20 is fitted into the respective keys 97 of the socket device 13.

By rotating the lamp device 14 in the mounting direction in a state in which the lamp device 14 is pressed against the socket device 13, the respective lamp pins 46 of the lamp device 14 move in the connecting holes 95 of the socket device 13 and hence are electrically connected to the respective terminals arranged inside the connecting holes 95 and the lateral groove portions 63 of the key grooves 61 of the cap 20 are fitted into the keys 97 of the socket device 13, whereby the lamp device 14 is supported by the socket device 13.

When power is distributed from the power source line to the lightening circuit 21 through the terminal of the socket device 13 and the lamp pins 46 of the lamp device 14, and the lighting power is supplied from the lightening circuit 21 to the semiconductor light-emitting elements 38 of the light-emitting module 18, the semiconductor light-emitting elements 38 are illuminated and the light is emitted from the light-emitting portion 34.

Heat generated by the semiconductor light-emitting elements 38 of the lighting light-emitting module 18 is mainly transferred to the substrate 33, is transferred from the substrate 33 to the base member 17, and is radiated into the air from the outer surface having the thermal radiating fins 27 of the base member 17 and, along with this, is transferred from the base member 17 to the cap 20 and is radiated from the cap 20 to the air or is transferred to the socket device 13 and the luminaire body 12 and is radiated therefrom.

Heat generated by the lighting circuit board 89 of the lightening circuit 21 is efficiently transferred to the cap 20 via the filling member 91 with which the lighting circuit board 88 or the lead electric wire 89a of the lighting circuit board 89 come into contact, and is radiated from the cap 20 into the air or is transferred to the socket device 13 and is radiated therefrom.

Also, when the cap 20 is assembled in a manufacturing process of the lamp device 14, a pair of the lamp pins 46 and the lightening circuit 21 connected with an electric wire in advance are assembled into the insulating body 47, and the insulating body 47 is assembled into the cap body 45 with the filling member 91 filled in advance in the projecting portion 53. The lighting circuit board holding portions 74 of the insulating body 47, the insulating portion 75 and the lighting circuit board 88 assembled into the cap body 45 are arranged inside the projecting portion 53 and are pressed against the filling member 91, whereby the insulating body 47 and the lighting circuit board 88 are fixed to the cap body 45 with the filling member 91.

The cap cover 48 is assembled into the opening of the cap body 45 of the assembled cap 20 and the cap 20 and the base member 17 are combined. At this time, the electric wire to be connected to the light-emitting module 18 from the lightening circuit 21 is drawn out from the substrate mounting surface 24 of the base member 17 through the wiring hole of the cap cover 48 and the wiring hole 28 of the base member 17, and is connected to the connector 36 of the light-emitting module 18 mounted in advance to the substrate mounting surface 24 of the base member 17.

The globe 19 is mounted on the base member 17 so as to cover the light-emitting module 18.

According to the lamp device 14, by using the insulating body 47 integrally including the pair of lamp pin mounting portions 73 where the lamp pins 46 are mounted respectively, the lighting circuit board holding portions 74 configured to hold the lighting circuit board 88, and the insulating portion 75 interposed between the inner surface of the cap 20 and the lightening circuit 21, a plurality of component functions are achieved with the single insulating body 47, the number of components may be reduced and simplification is achieved.

Therefore, when assembling the cap 20, the pair of lamp pins 46 and the lightening circuit 21 are assembled into insulating body 47, and the insulating body 47 is assembled into the cap body 45, whereby a pair of the lamp pins 46 and the lightening circuit 21 are assembled into the metallic cap body 45 in an insulated state, whereby improvement of the manufacturing properties is achieved.

Also, since the lamp pin mounting portions 73 of the insulating body 47 and the lamp pins 46 are held by the holding portions 85 of the cap cover 48 against the cap body 45 by combining the cap 20 having the cap cover 48 assembled thereto with the base member 17, displacement and coming apart of the lamp pin mounting portions 73 with respect to the cap body 45 is reliably prevented, and displacement and coming apart of the lamp pins 46 with respect to the lamp pin mounting portions 73 is reliably prevented.

The insulating body 47 includes a cover portions 80 arranged on the projecting portion 53 of the cap body 45 so as to oppose the side portion of the lamp pins 46, so that the insulating properties between the lamp pins 46 and the projecting portion 53 of the cap body 45 are secured.

A configuration in which a closing portion configured to close the upper surface of the insulating portion 75 is provided on the insulating portion 75 of the insulating body 47, and the closing portion is interposed between the end surface portion 60 of the projecting portion 53 of the cap 20 and the lightening circuit 21 may be adopted. Accordingly, further improvement of the insulating properties between the metallic cap 20 and the lightening circuit 21 is achieved.

Also, the lighting circuit board holding portions 74 may not be provided on the insulating body 47. In this case, a separate component configured to hold the lighting circuit board 88 may be provided.

Instead of the filling member 91, an insulative sheet may be provided.

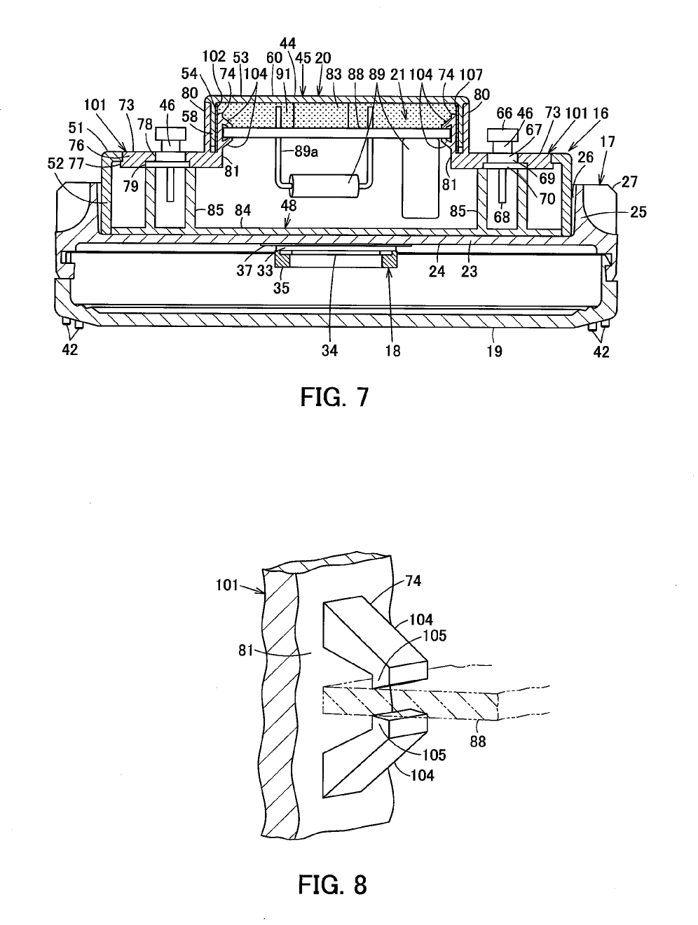

Subsequently, a second embodiment will be shown in FIG. 7 to FIG. 11. The same configurations as those in the first embodiment are designated by the same reference numerals and description will be omitted.

The first embodiment is configured with the single insulating body 47 integrally including the lamp pin mounting portions 73, the lighting circuit board holding portions 74, and the insulating portion 75. However, the second embodiment is configured with three components; a pair of insulating bodies 101 provided with the lamp pin mounting portions 73 and the lighting circuit board holding portions 74 and an insulating member 102 interposed between the inner surface of the cap 20 and the lightening circuit 21 as shown in FIG. 7.

The respective insulating bodies 101 includes the lamp pin mounting portions 73 having the same configuration as those in the first embodiment. However, the configuration of the lighting circuit board holding portions 74 is different. The lighting circuit board holding portions 74 includes a pair of holding claws 104 configured to hold the lighting circuit board 88 by clamping the upper and lower surfaces of the lighting circuit board 88 thereby. As shown in FIG. 7 and FIG. 8, the pair of holding claws 104 are formed so as to project from the respective lamp pin mounting portions 73, provided so as to project respectively from the side surfaces of the holding strips 81 arranged in the interior of the holding walls 58 of the projecting portion 53 of the cap body 45, the distal end sides of the respective holding claws 104 are thinner than the proximal end sides thereof, and the pair of holding claws 104 are inclined inwardly at an angle of 90° or smaller so that the distance between distal end sides of the pair of holding claws 104 becomes smaller than that between the proximal sides. Furthermore, claw portions 105 projecting so as to face each other are formed at distal ends of a pair of the holding claws 104, and the claw portions 105 are widened in the direction opposite from the holding strips 81, so that angles closer to the holding strips 81 form an acute angle. The dimension between the distal ends of a pair of the holding claws 104 is formed to be smaller than the thickness of the lighting circuit board 88.

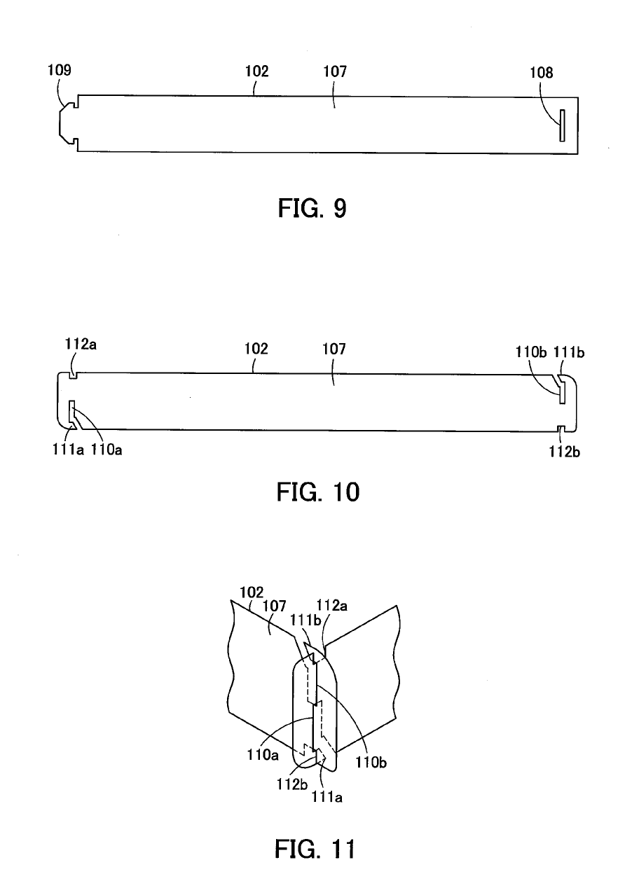

The insulating member 102 is provided with an insulating sheet 107 formed of a synthetic resin having insulating properties. As shown in FIG. 9, the insulating sheet 107 is formed into a band shape, is formed with an insertion hole 108 at an end thereof in the longitudinal direction and an locking portion 109 to be inserted into the insertion hole 108 and locked thereby in a state of being prevented from coming off is formed at the other end thereof. The insulating sheet 107 can be held in an annular shape by inserting the locking portion 109 into the insertion hole 108.

Alternatively, as shown in FIG. 10 and FIG. 11, the insulating sheet 107 is formed into a band shape, is formed at both end portions of the insulating sheet 107 in the longitudinal direction with groove portions 110a, 110b on one side in the width direction, and projecting portions 111a, 111b having a hook shape and projecting obliquely from ends on the outsides of the groove portions 110a, 110b, formed with depressed portions 112a, 112b on the other side in the width direction, so that the groove portions 110a, 110b, the projecting portions 111a, 111b, and the depressed portions 112a, 112b are formed symmetrically in the width direction. Corner portions which are formed with the groove portions 110a, 110b and the depressed portions 112a, 112b are formed into a curved shape to prevent the insulating sheet 107 from being torn from the corner portion. Then, as shown in FIG. 11, by combining the groove portions 110a, 110b at both ends to each other, the projecting portions 111a, 111b are caught and locked by the depressed portions 112a, 112b, so that the insulating sheet 107 can be held in the annular shape.

When assembling the cap 20 to the lamp device 14 in the assembly process, a pair of the insulating bodies 101 are mounted from both sides of the lighting circuit board 88 so as to press-fit the edge portion of the lighting circuit board 88 between a pair of the holding claws 104, and an upper and lower surfaces of the lighting circuit board 88 are clamped and held between the pair of holding claws 104.

At this time, since the distal end sides of the respective holding claws 104 are thinner than the proximal sides, and are inclined inward at an angle equal to or smaller than 90° so that the distance between the distal end sides is smaller than the distance on the proximal end sides, the pair of holding claws 104 are provided with flexibility. In addition, since the claw portions 105 of the pair of holding claws 104 are widened in the direction opposite from the direction of insertion of the lighting circuit board 88, press-fitting of the lighting circuit board 88 between the claw portions 105 of the pair of holding claws 104 is facilitated, so that the lighting circuit board 88 can be held by being clamped reliably between the pair of holding claws 104 after the press-fitting. In addition, since the lighting circuit board 88 catches the corner portions of the claw portions 105 projecting at an acute angle and prevents the same from coming apart therefrom in the direction in which the lighting circuit board 88 is dropped off from between the pair of holding claws 104, the insulating bodies 101 and the lighting circuit board 88 are reliably prevented from being disassembled during an assembly operation, so that the assemblability is improved.

The respective lamp pins 46 connected by the electric wire in advance to the lightening circuit 21 are mounted on the lamp pin mounting portions 73 of the respective insulating bodies 101 which hold the lighting circuit board 88.

With respect to the cap body 45 filled with the filling member 91 in the interior of the projecting portion 53 in advance, the insulating sheet 107 formed into an annular shape is arranged along the inner peripheral surface of the projecting portion 53 of the cap body 45 and a pair of the insulating bodies 101 attached with the lamp pins 46 and the lightening circuit 21 are assembled into the cap body 45.

The lighting circuit board holding portions 74 of the respective insulating bodies 101, and the lighting circuit board 88 assembled into the cap body 45 are arranged inside the projecting portion 53 and are pressed against the filling member 91, whereby the insulating bodies 101 and the lighting circuit board 88 are fixed to the cap body 45 with the filling member 91.

Since the holding strips 81 of the respective insulating bodies 101 assembled into the cap body 45 are arranged on the inner peripheral surface of the projecting portion 53 via the insulating sheet 107, the positions of the holding claws 104 which clamp and hold the lighting circuit board 88 are restricted, so that the state in which the lighting circuit board 88 is held in the projecting portion 53 of the cap body 45 is reliably maintained. Since the annular insulating sheet 107 is arranged along the inner peripheral surface of the projecting portion 53 of the cap body 45, the metallic cap body 45 and the lightening circuit 21 can be insulated reliably by the insulating sheet 107.

According to the lamp device 14, by using the pair of insulating bodies 101 integrally including the pair of lamp pin mounting portions 73 where the lamp pins 46 are mounted respectively, and the lighting circuit board holding portions 74 configured to hold the lighting circuit board 88, two component functions may be achieved simultaneously with the insulating body 101, the number of components may be reduced and simplification is achieved.

Therefore, by using the pair of insulating bodies 101, the pair of lamp pins 46 and the lightening circuit 21 can be assembled into the metallic cap body 45, whereby improvement of the manufacturing properties is achieved.

In addition, by using the insulating sheet 107 in addition to the pair of insulating bodies 101, the pair of lamp pins 46 and the lightening circuit 21 can be assembled in an insulated state with respect to the metallic cap body 45.

Not only the insulating sheet 107, the insulating member 102 may be formed into a cap shape arranged along the inner peripheral surface of the projecting portion 53 and the inside of the end surface portion 60 of the cap body 45.

In the embodiment described above, the lamp pins 46 of the lamp device 14 may be used for an electrical connection and support of the lamp device 14 on the socket device 13, and the key grooves 61 of the lamp device 14 and the keys 97 of the socket device 13 may not be provided. Alternatively, it is also possible to use the lamp pins 46 of the lamp device 14 only for the electric connection, and support the lamp device 14 to the socket device 13 only by the key grooves 61 of the cap 20. In this case, the lamp pins 46 may not be provided with the large-diameter portions 66.

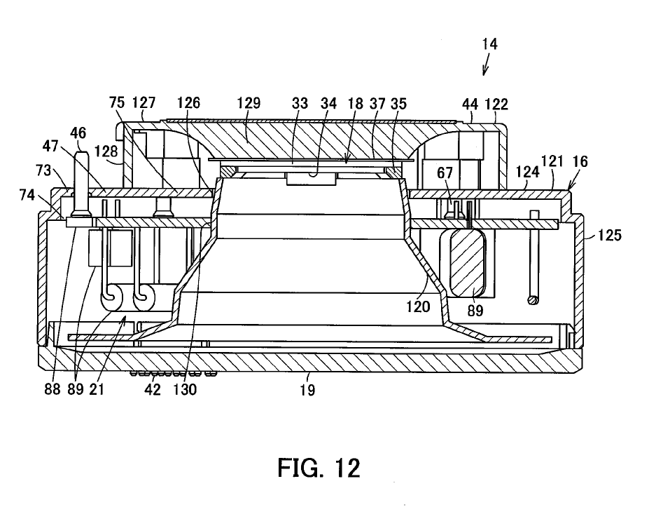

Subsequently, a third embodiment will be shown in FIG. 12. The same configurations as those in the first embodiment are designated by the same reference numerals and description will be omitted.

The lamp device 14 includes the housing 16, and the light-emitting module 18, the reflecting body 120 and the lightening circuit 21 are arranged in the housing 16, and the globe 19 is attached to the lower surface of the housing 16.

The housing 16 includes a case 121 opening downward, and a cap member 122 which constitutes a cap portion 44 mounted at the center of the upper surface of the case 121.

The case 121 is formed of a synthetic resin having insulating properties, and includes an end surface portion 124 on an upper surface thereof and a peripheral surface portion 125 projecting downward from the peripheral portion of the end surface portion 124, and is formed with a through hole 126 which allows penetration of an reflecting body 120 at the center of the end surface portion 124.

The cap member 122 is formed of a metallic material such as aluminum diecast or the like, and includes an end surface portion 127 on an upper surface thereof and a peripheral surface portion 128 projecting downward from the periphery of the end surface portion 127. A mounting portion 129 projecting toward the case 121 is formed integrally with the center of the lower surface of the end surface portion 127, and the light-emitting module 18 is attached to the lower surface of a mounting portion 129.

The reflecting body 120 is formed into a cylindrical shape opening upward and downward and widened downward, and is arranged around the light-emitting portion 34 of the light-emitting module 18 in a state in which the upper end thereof penetrates through the lighting circuit board 88 of the lightening circuit 21 and the through hole 126 of the case 121.

The lightening circuit 21 is stored in the case 121. The lighting circuit board 88 of the lightening circuit 21 is formed into an annular shape, and a through hole 130 which allows penetration of the luminaire body 120 therethrough is formed at the center thereof. The lighting circuit board 88 is held by being fitted to the peripheral portion thereof into the peripheral portion in the case 121.

The lamp pins 46 is formed into a cylindrical shape, and is attached to the peripheral portion of the end surface portion 124 of the case 121. The lamp pins 46 may be lamp pins 46 configured to input dimming signal, for example, instead of the pair of lamp pins 46 for power supply.

The case 121 has insulative properties, having the lamp pins 46 attached to the peripheral portion of the end surface portion 124, held by the peripheral portion of the lighting circuit board 88 fitted into the peripheral portion of the case 121, and has the center portion of the end surface portion 124 interposed between the cap member 122 and the lightening circuit 21 in the case 121. Therefore, the case 121 is used also as the insulating body 47. In other words, the peripheral portion of the end surface portion 124 of the case 121 is used as the lamp pin mounting portions 73 where the lamp pins 46 are attached, and the peripheral portion of the case 121 is used also as the pair of lighting circuit board holding portions 74 which hold the lighting circuit board 88 of the lightening circuit 21, and the center of the end surface portion 124 of the case 121 is used as the insulating portion 75 interposed between the inner surface of the cap portion 44 and the lightening circuit 21.

In this manner, the lamp device 14 includes a light-emitting portion 34 in which a semiconductor light-emitting elements 38 are used. The light-emitting portion 34 is arranged on the side of one of the surfaces of the housing 16. Provided on the side of the other surface of the housing 16 is a metallic cap portion 44 and a lamp pin 46 projecting to the side of the other surface of the housing 16. The lighting circuit 21 is stored in the housing 16. Then, the lamp device 14 includes the lamp pin mounting portion 73 where the lamp pins 46 are to be mounted and the insulating member 47 having the insulating portion 75 interposed between the inner surface of the cap portion 44 and the lighting circuit 21.

According to the lamp device 14, by using the insulating body 47 integrally including the pair of lamp pin mounting portions 73 where the lamp pins 46 are mounted, the lighting circuit board holding portions 74 configured to hold the lighting circuit board 88, and the insulating portion 75 interposed between the inner surface of the cap 20 and the lightening circuit 21, a plurality of component functions are achieved with the single insulating body 47, the number of components may be reduced and simplification is achieved.

In addition, since the case 121 may be used as the insulating body 47, the number of components can be reduced and simplification is achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 lighting apparatus
13 socket device
14 lamp device
16 housing
17 base member
20 cap
21 lightening circuit
34 light-emitting portion
38 semiconductor light-emitting element
44 cap portion
46 lamp pin
47 insulating body
73 lamp pin mounting portion
74 lighting circuit board holding portion
75 insulating portion
88 lighting circuit board
89 lighting circuit component
101 insulating body
102 insulating member
121 case

1. A lamp device comprising:
a light emitting portion having a semiconductor light-emitting element;
a housing having the light-emitting portion arranged on the side of one of the surfaces thereof and a metallic cap portion arranged on the side of the other surface;
a lamp pin projecting on the side of the other surface of the housing;
a lighting circuit stored in the housing; and
an insulating body having a lamp pin mounting portion where the lamp pin is to be mounted, and an insulating portion interposed between the inner surface of the cap portion and the lighting circuit.

2. The lamp device, comprising
a light emitting portion having a semiconductor light-emitting element;
a base member on which the light-emitting portion is mounted on one surface thereof;
a metallic cap mounted on the other surface of the base member;
a pair of lamp pins projecting from the cap;
a lighting circuit stored in the cap; and
an insulating body having a pair of lamp pin mounting portions where a pair of the lamp pins are to be mounted, and an insulating portion interposed between the inner surface of the cap and the lighting circuit, and is mounted to the cap.

3. A lamp device comprising:
a light emitting portion having a semiconductor light-emitting element;
a base member on which the light-emitting portion is mounted on one surface thereof;
a metallic cap mounted on the other surface of the base member;
a pair of lamp pins projecting from the cap;
a lighting circuit stored in the cap and having a lighting circuit board having lighting circuit components mounted thereon; and
a pair of insulating bodies having a lamp pin mounting portion where the lamp pin are to be mounted and a pair of insulating portions each having a lighting circuit board holding portion configured to hold the lighting circuit board and mounted on the cap respectively.

4. The lamp device according to claim 3, comprising an insulating member interposed between the inner surface of the cap and the lighting circuit.

5. The lamp device according to claim 1, wherein
the housing includes a case opening on the side of one of the surfaces thereof and a metallic cap portion provided on the other surface of the case, and the light-emitting portion is mounted on one surface of the cap portion,
the lighting circuit is stored in the case, and
the insulating body is provided integrally in the case.

6. A lighting apparatus comprising:
the lamp device according to claim 5, and
a socket device configured to mount the lamp device.
